(19) United States
(12) Patent Application Publication
(10) Pub. No.: US 2014/0109484 A1
(43) Pub. Date: Apr. 24, 2014

(54) ACCESS PANEL WITH SPRING-LOADED PLASTIC SUPPORT ARMS

(71) Applicant: Jerzy Szyjkowski, Barrie (CA)

(72) Inventor: Jerzy Szyjkowski, Barrie (CA)

(21) Appl. No.: 14/056,084

(22) Filed: Oct. 17, 2013

Related U.S. Application Data
(60) Provisional application No. 61/795,582, filed on Oct. 22, 2012.

(51) Int. Cl. E05C 19/00

(52) U.S. Cl. CPC E05C 19/005
USPC 49/465

(57) ABSTRACT

A removable cover for covering an access opening in a structure includes a plate member having two opposite side edges and front and rear sides. An elongate clamping member has two opposite end sections each forming an elongate clamping element and each extending towards a respective one of the side edges from a central region of the plate member. The clamping member is formed from a flexible material and is attached at a central portion thereof to the rear side of the plate. The two opposite end sections are substantially rigid while a central section has at least one flexible transverse portion. A separate spring device is mounted on the clamping member and has two elongate spring arms projecting outwardly in order to engage and bias the clamping elements towards engagement with the rear side of the plate member.

This application claims priority on the basis of previously filed U.S. Provisional Patent Application No. 61/795,582 filed Oct. 22, 2012.

This invention relates to access panels, access doors or grills, which can be used, for example, to cover an opening in the paneling of a wall or ceiling, and to provide ready access to installations accessible through the opening.

### BACKGROUND OF THE INVENTION

Removable access doors or covers for covering small openings in a wall or ceiling are known, including an access door or cover that includes a panel member and devices for attaching the panel member to the wall or ceiling. Access panels such as these are installed to provide an access to plumbing installations such as valves, cleanouts, pumps, and other such installations, or to enable the easy covering of openings made to carry out repair work on installations located behind wall or ceiling paneling.

Many of the known access doors and panels require some kind of framing in order that they can be used and secured. In many cases, the framing is attached to the studs of the wall. However, access panels which do not require framing are also known and such panels may be installed at any desired location where an opening is formed in the surface of the wall or ceiling. The provision of these access panels is especially useful to enable repair work to be carried out on installations located behind wall or ceiling paneling. They can also be useful in new structures or buildings.

In order for access panels that do not use framing to be securely installed into a wall opening, a spring-loaded clamping mechanism can be used to clamp the access panel against the interior surface of the paneling, adjacent to the opening. However, the known access panels of this type suffer from one particular drawback: the use of metal leaf springs in order to maintain a bias in the clamping mechanism such that it moves toward, and clamps against, the interior surface of the wall paneling once installed. Such leaf springs are easily distorted and bent out of shape if a significant force is applied outwardly from the inner surface of the panel, onto or near the outer ends of the leaf spring. Such distortion may render the access panel unusable.

The present disclosure provides a removable cover or access panel which is simple in its construction, comparatively easy to use, and durable and reliable, without adding substantial cost to the manufacturing process.

Furthermore the present disclosure provides a removable cover or access panel which employs a spring mechanism that is not permanently distorted during normal use.

### SUMMARY OF THE DISCLOSURE

According to one aspect of the disclosure, a removable cover suitable for covering an access opening in a structure comprises a plate member having two opposite side edges and at least one positioning device extending rearwardly from a rear side of the plate member and spaced inwardly from side edges of the plate member, and an elongate clamping member having two opposite end sections each forming an elongate clamping element and each extending towards a respective one of the side edges from a central region of the plate member. The clamping member is formed from a flexible material and is attached at a central portion thereof to the rear side of the plate member. The two opposite end sections are substantially rigid while a central section of the clamping member has at least one flexible transverse portion. A separate spring device is mounted on the clamping member and has two elongate spring arms projecting outwardly from ends of the spring device in different directions. Each of said spring arms engages and biases a respective one of the clamping elements towards engagement with the rear side of the plate member. Each clamping element can be pulled away from the plate member during installation of the cover and then moves back toward said plate member under biasing force applied by its respective spring arm when the cover has been installed over the access opening.

According to another embodiment of this disclosure, a removable cover for covering an access opening in a structure comprises a plate member having two opposite edges and front and rear sides and at least one positioning device extending rearwardly from a rear side of the plate member and spaced inwardly from side edges of the plate member, and an elongate clamping member having two opposite end sections each forming an elongate clamping element and each extending towards a respective one of the side edges from a central region of the plate member. The clamping member is formed from a flexible material and is attached at a central portion thereof to the rear side of the plate member. The two opposite end sections are substantially rigid and a central section of the clamping member has a flexible, transversely extending portion which is thinner than the relatively rigid end sections. A separate torsion spring is mounted on a rear side of the clamping member and has two elongate spring arms projecting substantially in opposite directions from a coiled central section of the torsion spring. Each of the spring arms engage a rear surface of a respective one of the clamping elements so as to bias the clamping element into engagement with the rear side of the plate member.

According to a further embodiment of this disclosure, a removable cover for covering an access opening in a structure comprises a cover member having two opposite side edges and front and rear sides and two elongate, pivotal clamping elements which are substantially aligned in their longitudinal direction. Each clamping element extends from a central section of the cover member towards a respective one of the side edges, is pivotally attached at an inner end thereof to the rear side of the cover member, and has a major outer longitudinal section which is substantially rigid. A torsion spring arrangement is mounted on the clamping elements and has two elongate spring arms projecting outwardly from a central section of the spring arrangement. Each of the spring arms engages a respective one of the clamping elements and biases its clamping element into engagement with the rear side of the cover member. For installation of the cover, each of the clamping elements can be pivoted away from the cover member for insertion into the access opening and subsequent engagement with a portion of the structure.

In one exemplary embodiment, the plate member has four edges.

Further features and advantages will become apparent from the following detailed description taken in conjunction with the accompanying drawings.

### BRIEF DESCRIPTION OF THE DRAWINGS

FIG. 1 is a perspective view of a first embodiment of a removable cover, constructed in accordance with the invention, this view showing the rear side of the removable cover, and depicting two alternative embodiments of positioning members;

FIG. 2 is an edge view of the first embodiment shown in cross-section, this view showing a partial four-sided positioning flange as the positioning member;

FIG. 3 is a perspective view of a second embodiment, this view showing the rear side of the removable cover; and

FIG. 4 is a cross-sectional edge view of the embodiment shown in FIG. 4.

### DETAILED DESCRIPTION OF EXEMPLARY EMBODIMENTS

A removable cover or access panel for covering an access opening 20 comprises a panel or plate member 1 with an attached or integral positioning means or member 2 extending rearwards from a rear surface 22 of the panel. As shown, the positioning means 2 is located inwardly from adjacent edges of the panel. The illustrated rectangular plate member 1 has four side edges 24 to 27.

The positioning means or member 2 functions to maintain the plate member 1, once installed in an access opening 20, in a desired horizontal and vertical position. The positioning means 2 is sized to fit within and near the edges of the opening 20 so as to prevent significant lateral or up-and-down movement of the plate member 1 once installed in the opening 20. In this way, the removable cover is maintained in a position that covers the access opening 20 shown in FIG. 2.

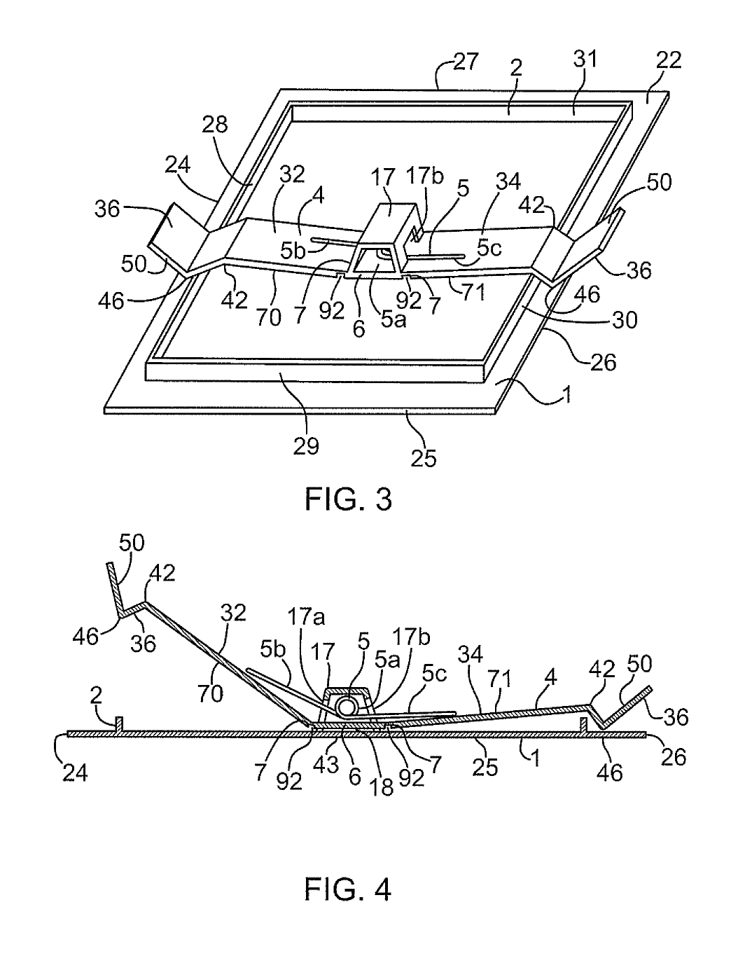

In one embodiment, most clearly depicted in FIG. 3, the positioning means or member 2 is a four-sided positioning flange 2 and each of the sides 28 to 31 of this flange is located inwardly from a respective adjacent edge of the plate member 1.

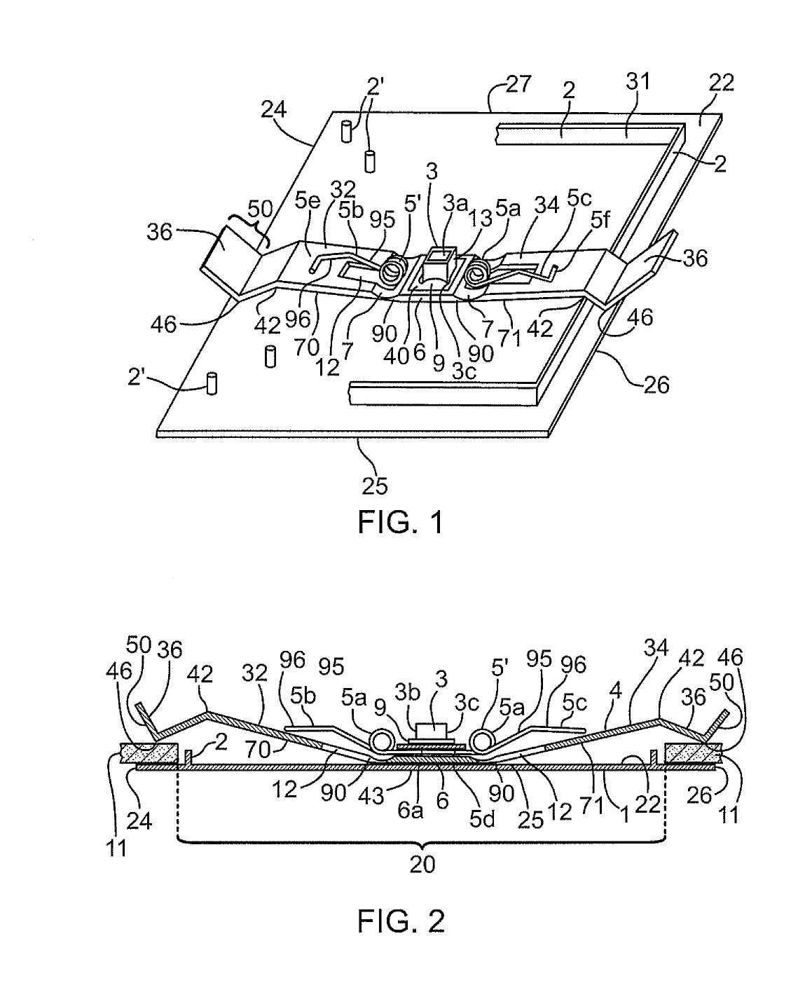

In an alternate embodiment, the positioning means 2 comprises a series of positioning studs 2′, typically four or more (shown in FIG. 1 as one of two illustrated alternate embodiments of the positioning means 2). In this embodiment, the studs 2′ are spaced from one another and are arranged in a pattern that repeats inwardly from the outermost studs 2′ closest to the edges of the plate member 1 to a point near a clamping member 4 used to clamp the plate member 1 against the opening 20 once installed. As shown the studs 2′ include studs at each of the four corners of the plate member, these all being spaced inwardly from the adjacent edges of the plate member. Optionally, each stud 2′ can be cleanly broken or snapped away from the rear surface 22 of the plate member 1 so as to leave little or no protrusion of the base of the stud 2′ above the rear surface 22 of the plate member 1. A breakable joint at the base of each stud can be provided for this purpose. Alternatively, the studs 2′ may be mechanically pressure-fitted into appropriately sized holes, not shown in the drawings, in the rear side 22 of the plate member 1, allowing the desired studs 2′ to be removed by pulling the studs 2′, with a force sufficient to overcome the pressure-fitting, away from the rear surface 22. In this way no stub portion of a stud 2′ can be left protruding from the rear side 22 of the plate member 1, so as to permit the plate member 1 to sit flush against the wall or ceiling paneling once installed in the access opening 20. The stud 2′ pattern may be any pattern, such as the vertices of a Cartesian grid. This embodiment permits the removable cover to be readily adaptable to differently sized access openings 20. For instance, if the opening 20 is too small to accommodate the cover with all of its studs 2′ intact, the user need only snap or pull away the desired amount of unwanted, outermost studs '2, so as to reduce the dimensions of the positioning means 2 and enable the cover to be snugly installed within the opening 20. This embodiment of the positioning means 2 further permits the cover to be adapted to fit within irregularly shaped access openings 20.

An exemplary removable cover has a plate member 1 having two opposite side edges 24 and 26, positioning means 2 as previously described, and two elongate clamping elements 32, 34 formed from a single, elongate clamping member 4 that has at least one flexing area 7 that is easily bendable. The at least one flexing area 7 separates one clamping element 32 from the other clamping element 34. The clamping elements 32 and 34 extend generally towards a respective one of the two opposite side edges 24 and 26, respectively, from a central region 43 of the plate member 1, the central region 43 representing an area that is centrally located, both widthwise and lengthwise, on the plate member 1. Each clamping element 32, 34 is spring-loaded by a torsion spring 5 located generally at the central region 43 and extending over the clamping elements 32, 34. The clamping member 4 is attached, at a midpoint of its underside, to the rear side 22 of the plate member 1 at the central region 43 of the plate member 1. The clamping member 4 is formed from a flexibly resilient material, such as a rubber-like, silicone, plastic, nylon, or other such or similar material that will allow a degree of flexibility, and the clamping elements 32, 34 are manufactured such that they are substantially stiffer than the at least one bendable flexing area 7. In this way, an outer end portion 36 of each clamping element 32, 34 can be pulled away from the rear side 22 of the plate member 1 during installation of the cover, and is biased to move back toward the plate member 1, by the torsion spring 5, when the cover has been installed into the access opening 20, as shown in FIG. 2. The bias in the torsion spring 5 (and hence in the clamping members 32, 34 against which the torsioning element 5 rests) to move back toward the rear side 22 of the plate member 1, is the result of the mechanical energy stored within, and the resultant bending stresses or torque exerted in the direction of the rear side 22 by, the torsion spring 5 as a result of the torsion spring 5 being bent away from the rear side 22 of the plate member 1. In this way, the combination of the torsion spring 5 and the clamping elements 32, 34 ensure the firm installation of the removable cover within the access opening 20, while the positioning means 2 ensures that the removable cover remains generally stationary, once installed.

Although the at least one flexing area 7 is formed from the same flexibly resilient material as the clamping elements 32, 34, it is formed in a manner that makes it easily bendable, whereas the clamping members 32, 34 are formed in a manner that makes them relatively stiff and inflexible. In an exemplary embodiment, the clamping elements 32, 34 are made stiffer than the one or more bendable flexing areas 7 of the clamping member 4 by being formed substantially thicker than the at least one flexing area 7. The flexing area 7 is conversely formed with a reduced thickness to make it easily bendable. It will be appreciated that the flexibility of the one or more flexing areas 7 relative to the clamping elements 32, 34 can be achieved by other means also, such as by the use of a reinforcing bar or rib formed from a rigid material, placed on or in the clamping elements 32, 34 in the case where the clamping elements 32, 34 are of a comparatively similar thickness as the one or more flexing areas 7.

It will be appreciated that the profile of the clamping member 4 is key to proper operation of the clamping member 4. The clamping member 4 has the aforementioned two outer end portions or opposite end sections 36, each of which is bent twice. The first bend 42 causes the end section 36 to extend both outwardly away from the central region 43 of the plate member 1 and towards the rear side 22 of the plate member 1. The second bend 46 causes the end section to extend both outwardly away from the central region 43 and away from the rear side 22 of the plate member 1. Also, each clamping element 32, 34 extends outwardly beyond its respective side edge 24, 26 as shown in FIGS. 1 and 5. The outermost end section 50 of the clamping element 4 extends at an acute angle to the rear side 22 of the plate member 1. As shown in FIG. 2, it is the second bend 46 of each clamping element 32, 34 which engages the internal surface of the paneling 11 after installation of the cover.

In illustrated embodiments, depicted in FIGS. 1 through 4, the torsion spring 5 is a helical torsion spring 5, preferably formed from a metallic, flexibly resilient rod that is formed into at least one helical coil 5a. Each end of the rod extends outwardly from and generally perpendicularly to the longitudinal axis of the at least one coil 5a to form two straight, elongate extensions 5b and 5c that extend outwardly from the coil(s) 5a in opposite directions from one another. Each elongate extension 5b and 5c maintains contact with, and applies a force against, one of the two elongate clamping elements 32 and 34, respectively. The force applied by the elongate extensions 5b, 5c is inward, toward the rear side 22 of the plate member 1. Contact between the elongate extensions 5b, 5c and the clamping elements 32, 34 is maintained when the clamping elements 32, 34 are at rest against the rear side 22 of the plate member 1 due to the resting angle between the rear side 22 and the elongate extensions 5b, 5c being less than the angle of inclination between the rear side 22 and the segments 70, 71 of the clamping elements 32, 34. The segment 70 or 71 is the portion of the clamping element 32 or 34 that extends from the central region 43 of the plate member 1 to the first bend 42. In this way, elongate extensions 5b, 5c, even when the clamping elements 32, 34 are at rest (i.e. when the bend 46 of each clamping element 32, 34 engages the rear side 22 of the plate member 1, as shown in FIGS. 1 and 5, and in FIG. 6 with respect to clamping element 34), are subjected to bending forces that produce mechanical energy within the spring 5 and result in a torque being applied in a direction opposite to the bending force, against the clamping elements 32, 34. Thus contact is maintained between the elongate extensions 5b, 5c and the clamping elements 32, 34 at all times.

As is known in the art, the further that a force is applied from the axis of rotation (in the presently described invention, the axis of rotation is represented generally by the coil 5a), the greater the torque. This phenomenon is commonly illustrated by pushing a door at a point near its hinges (i.e. near its axis of rotation) and at a point far from its hinges; the latter produces greater torque, making it easier to open the door. Referring to FIGS. 1 and 2, to ensure contact between the parts of the extensions 5b, 5c that are furthest from the coil 5a (i.e. the tips of the extensions 5b, 5c), and the clamping elements 32, 34, in some embodiments, the extension 5b or 5c comprises a first run 95 that extends rearwardly, above the clamping element 32 or 34 and away from the central region 43, and a second run 96 that extends from the end of the first run 95 down toward the rear side 22 of the plate member 1 to contact the clamping element 32 or 34. In this way, an angle is produced between the second run 96 and the clamping element 32 or 34 that is greater than 0°, thus ensuring contact with the tips of the extensions 5b, 5c to produce greater torque. It will be appreciated that by reducing the angles of inclination and declination of runs 95 and 96, respectively, relative to the clamping elements 32, 34, the tips of the extensions 5b, 5c can be made to contact the clamping elements 32, 24 further away from the axis of rotation, thereby maximizing the torque produced by the spring 5.

In some embodiments, the elongate extensions 5b, 5c, at their ends, jut to one side at approximately 90° to form two bent parts 5e, 5f that are generally parallel to the rear side 22 of the plate member 1, as shown in FIG. 1, in order to increase the contact surface with the clamping elements 32, 34. In yet other embodiments, the clamping elements 32, 34 can have holes (not shown) through which securing end parts pass, in order to securely affix the elongate extensions 5b, 5c to the clamping elements 32, 34. In this embodiment, the elongate extensions 5b, 5c at their ends jut inward toward the rear side 22, at an angle of approximately 90° to the elongate extensions 5b, 5c to form the two securing end parts.

In a preferred embodiment, and as shown in FIGS. 3 and 4, the helical torsion spring 5 has only one coil 5a, and is thus a single coil spring 5 which curves toward the rear side 22, as shown in FIG. 3. In one exemplary embodiments, the flexing area 7 is reduced in thickness by the formation of a notch 92, generally square shaped with the open end facing the rear side 22 of the plate member 1, as shown in FIGS. 3 and 4. It will be appreciated that the flexing areas 7 may be reduced in thickness by other cut-out portions having different shapes, or may be formed as a general sloping reduction in thickness over a suitable span of the clamping elements 32, 34.

Referring to FIGS. 3 and 4, in an exemplary embodiments of the single coil version of the invention, the clamping member 4 comprises the two clamping elements 32, 34 separated by two flexing areas 7 which flank a middle section 6. The middle section 6 is located at a midpoint of the clamping member 4, between the two clamping elements 32, 34.

In the single coil version of the cover shown in FIGS. 3 and 4, the spring 5 is retained by a spring enclosure 17 that is integrally formed with, or attached to, the clamping member 4 at a midpoint of the clamping member 4. The spring enclosure 17 has at least two opposite openings 17a and 17b facing the two opposite side edges, 24 and 26, of the plate member 1, respectively. The enclosure 17 covers the coil 5a of the spring 5, and the opposite openings 17a, 17b permit the elongate extensions 5b, 5c of the spring 5 to extend therethrough, and further accommodates movement of the two elongate extensions 5b, 5c either away from or towards the rear side 22 of the plate member 1, as would be the case when the clamping elements 32, 34 are correspondingly moved away from or towards the rear side 22 of the plate member 1 during installation or removal of the removable cover. In some instances, the clamping member 4 having the enclosure 17 thereon, is permanently attached to the central region 43 of the rear side 22 of the plate member 1 with a joint 18, which may be a stud or bolt fastener, an adhesive connection, or other such mechanical or chemical bonding means.

In an alternate embodiment, and as shown in FIGS. 1 and 2, the helical torsion spring 5 has two coils 5a separated by an intermediate section 5d of the rod, this construction forming a double coil spring 5′. The double coil spring 5′ is used with the previously described clamping member 4 having the middle section 6 and two flexing areas 7. In this embodiment, the two coils 5a are each situated atop a respective one of the flexing areas 7, most clearly shown in FIG. 1, and the intermediate section 5d spans the width of the middle section 6 that is flanked by the two flexing areas 7 as shown in FIG. 2.

Still referring to FIGS. 1 and 2, in some embodiments, the plate member 1 is formed in its central region 43 with a connecting member 3. Preferably, this connecting member 3 is integrally formed on the rear side 22 of the plate member 1. Alternatively, the connecting member 3 may be attached to the plate member 1. The illustrated connecting member 3 has a rectangular or square cross-section in a plane parallel to the rear side 22 of the plate member 1 and is hollow with an open end 3a (shown in FIG. 1) opposite the rear side 22 of the plate member 1. The member 3 has slots 13 on opposing walls 3b, 3c of the connecting member 3. These slots extend from the open end 3a of the connecting member 3 to a base of the connecting member 3. The opposing walls 3b and 3c each face a respective one of the two opposite side edges 24 and 26 of the plate member 1.

Still with reference to FIGS. 1 and 2, in some embodiments, each clamping element 32, 34 has a rectangular cut-out 12 extending from its respective flexing area 7 to a point intermediate between the flexing area 7 and the end of the straight, elongate extension 5b or 5c of the helical torsion spring 5 when the extensions 5b, 5c are placed atop the clamping elements 32, 34. Also, the clamping member 4 has a substantially rectangular hole 40 formed at the centre thereof, in the middle section 6, and through which the connecting member 3 extends. The cut-outs 12 permit removal from, or insertion onto, the clamping member 4 of a double coil spring 5′. To insert the spring 5′, the elongate extensions 5b, 5c are bent toward one another until the ends of the extensions 5b, 5c no longer extend beyond the edges of the cut-outs 12 when the spring 5 is centrally aligned with the middle section 6. In this bent configuration, the coils 5a and the extensions 5b, 5c can be inserted through the cut-outs 12 from the underside of the clamping member 4. Once inserted, the extensions 5b, 5c are released and the counteracting torque causes the extensions 5b, 5c to move towards and apply force against the clamping elements 32, 34. This force is applied by the portion of each of elongate extension 5b, 5c that extends beyond the cut-outs 12 and therefore contact the clamping elements 32, 34.

Alternatively, the spring 5′ can be positioned on one side of the middle section 6 such that the extension 5b or 5c extending out to the opposite side no longer extends beyond the edge of its respective cut-out 12. That extension, 5b or 5c, can then be inserted through the cut-out 12, and the spring 5′ can then be moved to the other side of the middle section 6 until the other extension, 5b or 5c, clears the edge of its respective cut-out 12. If the clearance is not possible by simply moving the spring 5′, the extension 5b or 5c remaining to be inserted may be bent to the extent required in order to clear the edge of the cut-out 12, inserted through the cut-out 12, and subsequently released. The spring 5′ is then centered on the middle section 6 such that the intermediate section 5d spans the middle section 6 and the coils 5a rest atop the flexing areas 7.

In the embodiment shown in FIGS. 1 and 2, the clamping member 4, having the spring 5′ attached thereto, is attached to the plate member 1 by lowering the clamping member 4, underside first, onto the plate member 1 with the hole 40 aligned with the connecting member 3 and the slots 13 aligned with the intermediate section 5d that spans the gap between the two coils 5a. Subsequently, the clamping member 4 and the spring 5′ are firmly attached to the rear side 22 of the plate member 1 by affixing a retaining member 9 onto the middle section 6 and around the connecting member 3. The retainer 9 secures the middle section 6 to the connecting member 3. The retainer 9 may be a nut, or may have self-locking tabs that seize the connecting member 3 and the middle section 6. Alternatively, the clamping member 4 having attached thereto the spring 5′ can be secured to the rear side 22 of plate member 1 by adhesive, heat melting of the outermost portion of the connecting member 3, bonding, use of a c-clamp, or other such or similar method. In this way, the double helical torsion spring 5′ is held against the rear side 22 of the plate member 1 by an inner surface 6a of the middle section 6.

In all embodiments, the generally rectangular shape of the connecting member 3, the clamp 15 (which rectangular shape is not illustrated), or the enclosure 17 prevents the clamping member 4 from swinging out of its proper position.

The installation of the removable cover will now be explained. The first step in the installation procedure for the removable cover or access panel, after an adequate opening 20 in the wall or ceiling panel has been made, is to bring the plate member 1 level with the opening 20 and to arrange it at a small angle in relation to the outer surface of the wall or ceiling panel. The outer end portion 36 of one of the clamping elements, for example clamping element 32, is brought into position so that it projects to the rear of the panel. Then, the installer slides the cover in the direction toward which clamping element 32 extends from the central region 43 (e.g. to the left), resulting in the clamping element 32 being engaged with the rear surface of the paneling 11. The plate member 1 is then moved to the left a sufficient distance that the end portion 36 of the opposite clamping element (i.e. clamping element 34) is moved into the area directly in front of the opening 20, at which point the outer end portion 36 of clamping element 34 can be moved rearwardly into the opening 20. The plate member 1 can then be forced or moved to the right. Due to the slope of the outermost end section 50 of the end portion 36, this movement will result in the outer end portion 36 of clamping element 34 being engaged with the rear surface of the paneling 11. Then, to complete the installation procedure, the plate member 1 is properly aligned, both vertically and horizontally, with the opening 20 so that the sides of the positioning member 2 can pass into the opening 20 upon release of the plate member 1 into the opening 20.

Alternatively, the clamping elements 32, 24 can be simultaneously bent toward one another until their respective end portions 36 no longer extend beyond the access opening 20. The plate member 1 can then be moved rearwardly with the sides of the positioning member 2 aligned to fit within the access opening 20, and then the clamping elements 32, 34 can be released such that they engage with the rear surface of the paneling 11. In either case, the plate member 1 is biased to move into the opening 20 by the force applied against the clamping elements 32, 24 by the torsion spring 5 or 5′, as previously explained. It will be appreciated that the latter-described method of installation, requiring a user to simultaneously reach his or her arms around to the rear of the plate member 1 to maintain both clamping elements 32, 34 in inwardly bent positions, may be difficult for a user to attempt with larger removable covers.

In order to remove the cover or access panel, the above described installation steps are followed in reverse. Alternatively, because of the easily bendable flexing area or areas 7, and the torsion means 5 or 5′, the panel 1 can simply be pulled away from the opening 20 in order to remove the panel, without the risk of permanently distorting or bending the clamping member 4 such that plate member 1 cannot be reused, as is the case with similar removable covers employing metal leaf springs.

In all described embodiments, the plate member 1 and the clamping members 4, whether comprised of two clamping elements 32, 34 separated by a flexing area 7, or two clamping elements 32, 34 separated by two flexing areas 7 that flank a middle section 6, are preferably entirely molded out of plastic. In the alternative, the clamping member 4 can be made of a suitable sheet metal or out of wire. Also, if desired, in all embodiments, the plate member 1, the clamping member 4, and the retaining member 9, clamp 15, or enclosure 17, can be integrally molded as a single piece of plastic, thus avoiding the need for any assembly by the user.

It will be appreciated that larger sizes of the present removable cover or access panel can incorporate a series of clamping members 4, each having a spring 5 or 5′ and a means for securing the clamping member 4 and the spring 5 or 5′ to the plate member 1, as previously described.

Although a complete four-sided positioning flange 2 is shown in FIG. 5 and in part in FIG. 1, it will be understood by those skilled in the art that the flange can be a partial flange which will still help ensure proper installation of the removable cover and prevent it from sliding away from the access opening 20.

It will be appreciated that once the removable cover of the invention has been installed over an opening 20, it presents a very aesthetic appearance as the external surface thereof is not interrupted by any screws or latching mechanisms. Furthermore, the removable cover described herein is inexpensive and can provide a very reliable cover for an opening given its robust design having the flexing area(s) 7 and the torsioning spring 5 or 5′, which, as noted, is not susceptible to the same risk of permanent distortion or loss of flexibility as are other similar access panels employing metal leaf springs. Furthermore, covers constructed in accordance with the invention can be used with different kinds of paneling having different thicknesses. The cover can be installed or removed very quickly when required for repairs or servicing an installation located behind the cover.

The preferred positioning means or member 2 leaves a sufficient margin between itself and the adjacent edge of the plate member 1 to allow for any imperfections in the edges of the access opening 20 while still permitting the opening 20 to be properly covered. Furthermore, the provision of the positioning means 2 serves as a stiffener of the plate member 1.

It will be understood that the clamping member 4 can be attached in various ways to the rear side 22 of the plate member 1. Depending on the materials used for the plate member 1 and the clamping member 4, the clamping member 4 can be attached by adhesive, welding, bonding, or by means of a standard fastener, as previously noted.

It is to be understood that what has been described are exemplary embodiments of the invention. The scope of the claims should not be limited by the embodiments set forth above, but should be given the broadest interpretation consistent with the description as a whole.

We claim:

1. A removable cover for covering an access opening in a structure, said removable cover comprising:
a plate member having two opposite side edges and front and rear sides;
at least one positioning device extending rearwardly from said rear side of the plate member and spaced inwardly from side edges of the plate member;
an elongate clamping member having two opposite end sections each forming an elongate clamping element and each extending towards a respective one of said side edges from a central region of the plate member, said clamping member being formed from a flexible material and being attached at a central portion thereof to the rear side of the plate member, said two opposite end sections being substantially rigid while a central section of the clamping member has at least one flexible transverse portion; and
a separate spring device mounted on the clamping member and having two elongate spring arms projecting outwardly from ends of the spring device in different directions, each of said spring arms engaging and biasing a respective one of the clamping elements towards engagement with the rear side of the plate member,
wherein each said clamping elements can be pulled away from said plate member during installation of said cover and then moves back toward said plate member under biasing force applied by its respective spring arm when said cover has been installed over said access opening.

2. A removable cover according to claim 1 wherein said clamping member is made from a flexible plastics material.

3. A removable cover according to claim 1 wherein said spring device is a helical torsion spring, a central section of the spring device comprises at least one helical coil, and each spring arm extends substantially perpendicular to a central axis of said at least one helical coil.

4. A removable cover according to claim 1 wherein said spring device is a helical torsion spring mechanism, a central section of the spring device comprises two spaced-apart helical coils connected to each other, and each spring arm extends substantially perpendicularly to a central axis of a respective one of the helical coils.

5. A removable cover according to claim 2 wherein each spring arm is bent at its outer end to form an end section that extends parallel to a rear surface of the clamping element.

6. A removable cover according to claim 1 wherein each spring arm is bent at its outer end to form an end section extending substantially perpendicular to an adjacent section of the spring arm and parallel to the adjacent rear surface of its clamping element.

7. A removable cover according to claim 1 wherein the central section of the clamping member has two, spaced-apart, flexible transverse portions, each located at an inner end of a respective one of the clamping elements.

8. A removable cover according to claim 1 wherein said at least one positioning device comprises a plurality of positioning studs at least some of which are positioned at corners of the plate member but spaced inwardly therefrom.

9. A removable cover according to claim 8 wherein at least a portion of said positioning studs are removable to allow the cover to be installed in a smaller access opening.

10. A removable cover for covering an access opening in a structure, said removable cover comprising:
a plate member having two opposite side edges and front and rear sides;
at least one positioning device extending rearwards from said rear side of the plate member and spaced inwardly from side edges of the plate member;
an elongate clamping member having two opposite end sections each forming an elongate clamping element and each extending towards a respective one of said side edges from a central region of the plate member, said clamping member being formed from a flexible material and being attached at a central portion thereof to the rear side of the plate member, said two opposite end sections being substantially rigid and a central section of the clamping member having a flexible, transversely extending portion which is thinner than the relatively rigid end sections, and
a separate torsion spring mounted on a rear side of the clamping member and having two elongate spring arms projecting substantially in opposite directions from a coiled central section of the torsion spring, each of the spring arms engaging a rear surface of a respective one of the clamping elements so as to bias the clamping element into engagement with the rear side of the plate member.

11. A removable cover according to claim 10 wherein said clamping member is made from a flexible, resilient plastics material.

12. A removable cover according to claim 10 wherein each clamping element has a cut-out formed therein to accommodate a section of a respective one of the spring arms and permit relative movement between the clamping element and its spring arm.

13. A removable cover according to claim 10 wherein said clamping member includes a spring enclosure having two opposite openings respectively facing said opposite side edges of the plate member, said coiled central section of the torsion spring being located in said enclosure and each spring arm extending from a respective one of said opposite openings.

14. A removable cover according to claim 13 wherein said spring enclosure is integrally formed on said clamping member at said central section thereof.

15. A removable cover according to claim 11 wherein said central section of the clamping member has an additional flexible, transversely extending portion which is thinner than the relatively rigid end sections and is spaced from the first mentioned flexible, transversely extending portion.

16. A removable cover for covering an access opening in a structure, said removable cover comprising:
a cover member having two opposite side edges and front and rear sides;
two elongate, pivotal clamping elements which are substantially aligned in their longitudinal direction, each clamping element extending from a central section of the cover member towards a respective one of said side edges, being pivotally attached at an inner end thereof to the rear side of the cover member, and having a major outer longitudinal section which is substantially rigid; and
a torsion spring arrangement mounted adjacent the clamping elements and having two elongate spring arms projecting outwardly from a central section of the spring arrangement, each of said spring arms engaging a respective one of the clamping elements and biasing its clamping element into engagement with the rear side of the cover member,
wherein, for installation of the cover, each of said clamping elements can be pivoted away from the cover member for insertion into the access opening and subsequent engagement with a portion of the structure.

17. A removable cover according to claim 16 wherein each clamping element is bent twice to form first and second bends, the first bend causing the major outer longitudinal section to extend both outwardly away from the central section of the cover member and towards the rear side of the cover member and the second bend causing the major outer longitudinal section to extend both outwardly away from the central section and away from the rear side of the cover member.

18. A removable cover according to claim 16 wherein said torsion spring arrangement includes two spaced-apart helical coils, each of said spring arms extending from one end of a respective one of the helical coils.

19. A removable cover according to claim 16 wherein said cover member includes a four-sided positioning flange extending rearwardly from the rear side of the cover member and spaced inwardly from each side edge of the cover member.

20. A removable cover according to claim 16 wherein said cover member includes a plurality of positioning studs, at least some of which are positioned at corners of the cover member but spaced inwardly therefrom.
